(19) United States
(12) Patent Application Publication
(10) Pub. No.: US 2010/0153633 A1
(43) Pub. Date: Jun. 17, 2010

(54) PC architecture using fast NV RAM in main memory

(75) Inventor: Hsu Kai Yang, Pleasanton, CA (US)

Correspondence Address: SAILE ACKERMAN LLC, 28 DAVIS AVENUE, POUGHKEEPSIE, NY, 12603, US

(73) Assignee: MagIC Technologies, Inc.

(21) Appl. No.: 12/316,502

(22) Filed: Dec. 11, 2008

(51) Int. Cl. G06F 12/00

(52) U.S. Cl. 711/104; 711/105; 711/E12.001

(57) ABSTRACT

Systems and methods for a PC or server architecture have been disclosed. The architecture is characterized by using non-volatile RAM modules, such as MRAM modules, for at least a part of the main memory, thus accelerating the power-on sequence of the computer. Components, which were stored in prior art either in battery backed CMOS Modules or in flash memory have been deployed in the non-volatile part of the main memory. Such components can be power-on self test codes, system configuration information, device drivers, a portion of the Operating system, and a portion or all of application programs and related application data.

### BACKGROUND OF THE INVENTION

(1) Field of the Invention

This invention relates generally to PC architecture and relates more specifically to main memory of a PC, wherein at least a part of a main memory comprises fast non-volatile RAM.

(2) Description of the Prior Art

FIG. 1 prior art shows a conventional PC architecture comprising a CPU 1, a memory controller 2, a main memory 3 of dynamic random access memory (DRAM) type, a graphic card 4, an I/O controller 5, a battery backed CMOS configuration RAM 6, a Super I/O controller 7, and a flash memory 8 for Basic Input/Output System (BIOS).

BIOS refers, in part, to the firmware code (a type of boot loader) run by a PC when first powered on. The primary function of the BIOS is to identify and initialize system component hardware (such as the video display card, hard disk, and floppy disk) and some other hardware devices. This is to prepare the machine into a known low capability state, so other software programs stored on various media can be loaded, executed, and given control of the PC. This process is known as booting, or booting up, which is short for bootstrapping.

The I/O controller 5 controls e.g. IDE hard drives, USB I/O, Ethernet or other LAN connections and I/O for Audio support. The Super I/O controller 7 controls e.g. a serial port, an parallel port a floppy disk, a keyboard, and a mouse.

The low cost, high density volatile DRAM modules 3 are connected to the CPU 1 via the memory controller 2. DRAM modules are usually on a fast memory bus, such as Peripheral Component Interconnect (PCI), PClx or PCIe buses. The BIOS, typically around 2 MB, is usually implemented using slow flash memory 8 is on a slower I/O bus, such as ISA, EISA, etc. A small battery backed CMOS RAM 6 stores system configuration information.

Upon power up, the BIOS executes various power-on self tests (POST), identifies the system configuration, loads the device drivers and a portion of the Operating system into the main memory 3. The BIOS information is also shadowed in main memory 3 for faster operation.

A major disadvantage of the prior art implementations is that this power-up sequence can take tens of seconds, even minutes.

This relatively long sequence is received as a major problem by many computer users. It is a challenge for the designers of such systems to speed-up the power-up sequence of a PC.

There are patents or patent publications known dealing with deployment of memories in personal computers or motherboards.

U.S. patent (U.S. Pat. No. 5,999,476 to Dutton et al.) proposes a shared interface to a non-volatile memory including a first storage area for BIOS and a second storage area (e.g., for multimedia data) providing an integrated configuration which saves the cost and space of duplicating memory elements to support multiple data and program types in personal computers. The BIOS information is shadowed from the non-volatile memory to a second memory (e.g., a PC main memory). Thereafter, the BIOS information is accessed in the second memory and the information of the second storage area is accessed via the shared interface. The storage may be integrated upon personal computer system boards without a degradation in performance or an increase in pin count of the board memory because the same pins are used at different times for different memory portions. Accordingly, a storage system is provided to meet the demands of increasing storage requirements without a corresponding increase in cost, space or performance.

U.S. patent (U.S. Pat. No. 7,310,747 to Lauterbach et al.) discloses a system and method for diagnostics execution in which diagnostics code is stored in a designated partition on a removable nonvolatile memory device, such as a compact flash or a personal computer (PC) card that is interfaced with the motherboard of a file server system. The file server system firmware is programmed in such a manner that, upon receipt of a diagnostics command, a normal boot mechanism is interrupted, and a diagnostics boot is performed. The firmware is programmed to probe the removable nonvolatile memory device, and to load the diagnostics code contained thereon into main memory and to execute the diagnostics in response to an initiation by an operator's key sequence. In accordance with a further aspect of the invention, the data produced as a result of the diagnostics test sequence is captured and stored in a maintenance log in another partition on the compact flash that has been pre-assigned for that purpose. Such diagnostics log data can be readily retrieved at a later time. In addition, the diagnostics code may be updated without system downtime.

U.S. patent (U.S. Pat. No. 7,447,894 to Oshiba et al.) discloses a microcomputer capable of reducing a board area, enhancing the security, and improving the usability. A microcomputer to be used in a notebook PC is disclosed, in which programs of a keyboard/power management BIOS and a system BIOS are stored in a built-in flash memory ROM. In order to set read (R)/write (W) protect to the BIOSes stored in the flash memory ROM, a read/write protect setting register is provided, and at initial setting after the release of reset, flags of R/W permission, R permission/W prohibition, W permission/R prohibition, and R/W prohibition are set to this register by a central processing unit CPU. By doing so, it becomes possible to achieve protection such as the prevention of error writing of the BIOS and the like between a host machine and the flash memory ROM via a LPC bus.

### SUMMARY OF THE INVENTION

A principal object of the present invention is to speed-up the power-on sequence of a PC.

A further object of the present invention is to use fast non-volatile memory modules at least for a part of a main memory.

A further object of the present invention is to store the BIOS and configuration data in non-volatile main memory.

Furthermore another object of the present invention is to store the system drivers in non-volatile main memory.

Another object of the present invention is to avoid shadowing Bios information from a flash memory to the main memory.

In accordance with the objects of this invention a method to accelerate a power-on sequence of a PC or a server has been achieved. The method invented comprises the steps of: (1) providing a memory controller and a main memory of the PC, (2) implementing said main memory using partly non-volatile RAM modules and partly volatile RAM modules; and (3) storing power-on self test codes in said non-volatile RAM modules.

In accordance with the objects of this invention a system a PC having an accelerated power-on sequence has been achieved. The PC comprises a CPU, a memory controller controlling a main memory, wherein the memory controller is connected to said CPU, and said main memory implemented using partly non-volatile RAM modules and partly volatile RAM modules, wherein the main memory is connected to said memory controller.

### BRIEF DESCRIPTION OF THE DRAWINGS

In the accompanying drawings forming a material part of this description, there is shown:

FIG. 1 prior art illustrates a block diagram of a conventional PC architecture.

FIG. 2 shows a block diagram of a PC architecture of the present invention.

FIG. 3 shows a flowchart of a method invented to accelerate power-on sequence of a PC or a server.

### DESCRIPTION OF THE PREFERRED EMBODIMENTS

The preferred embodiments disclose a PC architecture using a non-volatile RAM, such as e.g. a magnetic random access memory (MRAM), at least as part of a main memory. This architecture applies for servers as well.

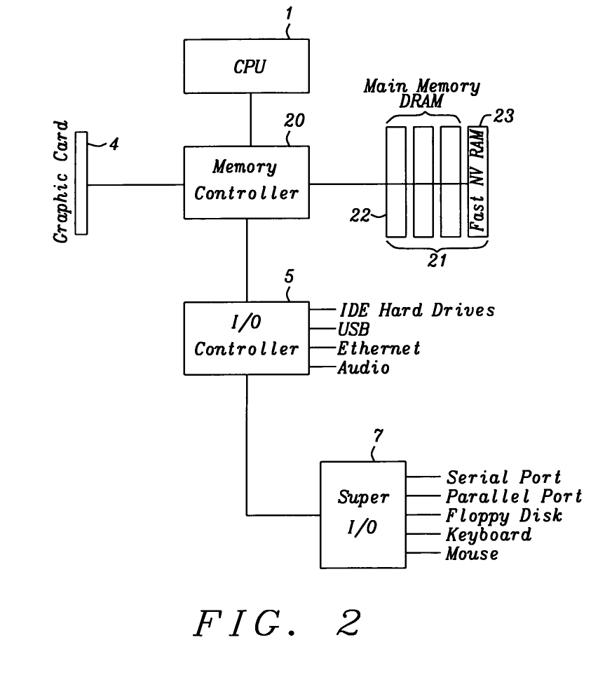

FIG. 2 shows a block diagram of a preferred embodiment of PC architecture invented. The architecture comprises a CPU 1, a memory controller 20, capable of controlling a volatile RAM and a nonvolatile RAM, a main memory 21, comprising partly a dynamic random access memory (DRAM) modules 22, and partly non-volatile RAM modules 23, such as e.g. MRAM modules. Other types of non-volatile memories would be applicable as well as long as they correspond in regard of endurance and speed to MRAMS. Furthermore the architecture comprises a graphic card 4, an I/O controller 5, and a Super I/O controller 7.

It should be understood that the characteristics of DRAM and MRAM could be slightly different, such as latency or recovery time of some operations, therefore the memory controller 20 should be adaptive to these differences.

In regard of supporting both DRAM and MRAM modules the access can be performed by different Chip (Rank) Select pins. Other buses (address and data) or control signals can be common.

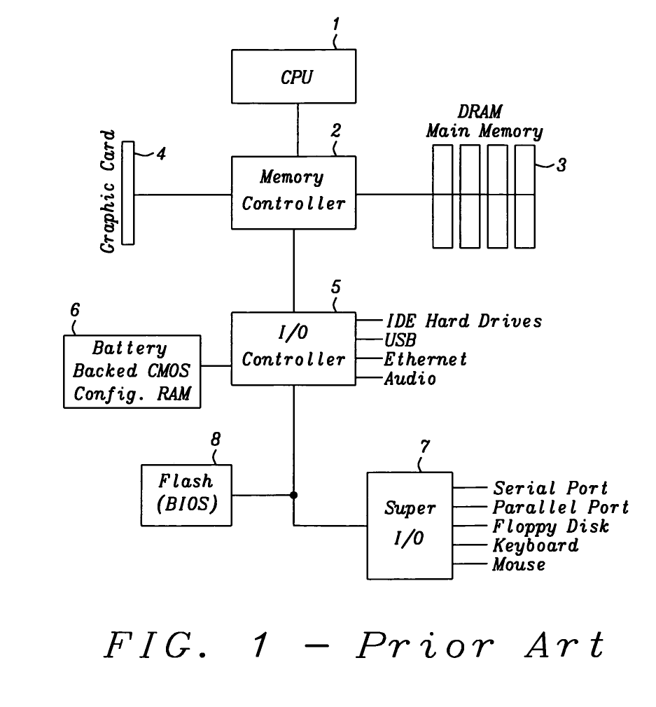

It has to be understood that a battery backed CMOS configuration RAM 6, and a flash memory 8 for Basic Input/Output System (BIOS), shown in FIG. 1 prior art, is no more required with the architecture of the present invention.

Using fast non-volatile RAM, such as MRAM, having unlimited endurance, as part of the main memory as shown in FIG. 2, provides significant advantages over using solely volatile RAM as e.g. DRAM. By replacing volatile RAM modules of the main memory by non-volatile RAM, such as e.g. MRAM, it is possible to store the BIOS and the battery backed CMOS RAM data, as shown in FIG. 1 prior art storing configuration data, in main memory using non-volatile (NV) RAM. All system device drivers, part of the Operating System (OS) and active used application programs can also be stored in the main memory NV RAM. Thus, at power on, the PC or server can be ready for operation at much shorter time as in prior art.

It has to be understood that, compared to prior art, the time consuming loading of device drivers and of parts of the Operating system into main memory is no more required with the present invention.

Presently MRAM modules cost more than DRAM modules, therefore it may not be practical to implement the entire main memory with MRAM modules, therefore preferably only a part of the main memory could be implemented with MRAM modules and the rest of the main memory could be implemented with DRAM modules. As MRAM technology matures the main memory could be totally implemented with MRAM modules at lower cost. For example all of the battery backed CMOS configuration parameters can be stored in MRAM as one of the first components to be moved from DRAM to MRAM.

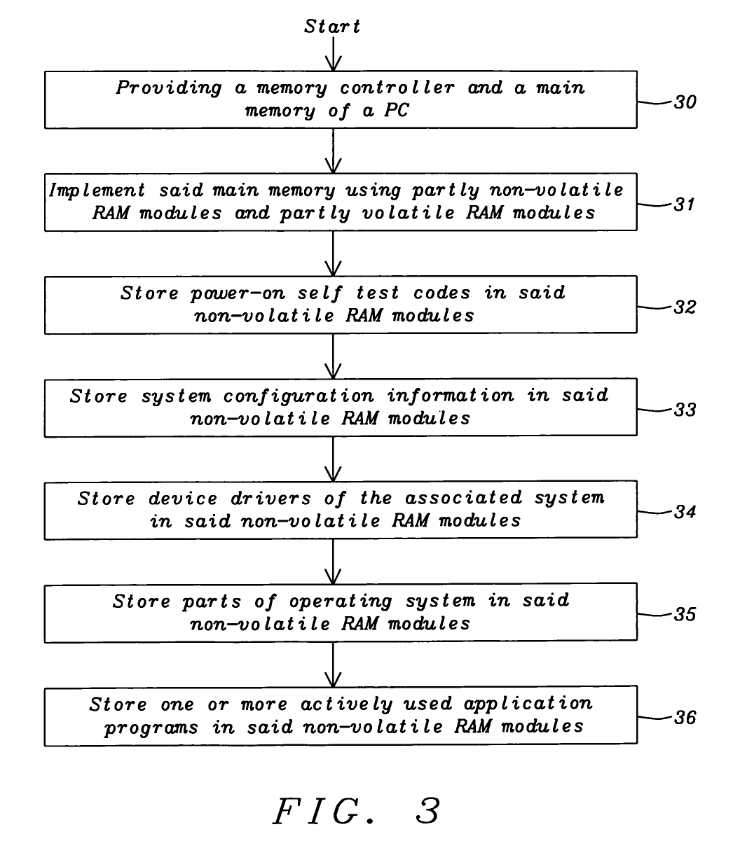

FIG. 3 illustrates a flowchart of a method invented to accelerate a power-on sequence of a PC or of a server. Step 30 of the method of FIG. 3 illustrates the provision of a memory controller and a main memory of a PC or of a server. Step 31 describes an implementation of said main memory using partly non-volatile fast RAM modules and using partly volatile RAM modules. In a preferred embodiment MRAM modules are used for non-volatile RAM modules and DRAM modules for volatile RAM modules. Other RAM technologies could also be used for volatile or non-volatile RAM modules. It would be possible, especially as MRAM technology is maturing, to use non-volatile RAM modules, e.g. MRAM modules, exclusively for the main memory. Step 32 shows the storing of power-on self test codes in said non-volatile RAM modules. Step 33 describes the storing of system configuration information in said non-volatile RAM modules, step 34 illustrates storing of device drivers of the associated system in said non-volatile RAM modules, step 35 illustrates storing of parts of the operating system in said non-volatile RAM modules, and step 36 illustrates storing of one or more actively used application programs in said non-volatile RAM modules. In case enough non-volatile RAM is available a portion of or all application programs and related application data can be stored in the non-volatile RAM modules of the main memory.

In case only a part of the main memory is implemented using fast non-volatile RAMs one or more storing steps outlined above can be omitted.

While the invention has been particularly shown and described with reference to the preferred embodiments thereof, it will be understood by those skilled in the art that various changes in form and details may be made without departing from the spirit and scope of the invention.

What is claimed is:

1. A PC having an accelerated power-on sequence comprising:
a CPU;
a memory controller controlling a main memory, wherein the memory controller is connected to said CPU; and
said main memory implemented using partly non-volatile RAM modules and partly volatile RAM modules, wherein the main memory is connected to said memory controller.

2. The system of claim 1 wherein said non-volatile RAM modules are MRAM modules.

3. The system of claim 1 wherein said volatile RAM modules are DRAM modules.

4. The system of claim 1 wherein said main memory is consisting exclusively of non-volatile RAM.

5. The system of claim 1 wherein power-on self test codes are stored in said non-volatile RAM module part.

6. The system of claim 1 wherein system configuration information is stored in said non-volatile RAM module part.

7. The system of claim 1 wherein device drivers associated with the system are stored in said non-volatile RAM module part.

8. The system of claim 1 wherein a portion of Operating system is stored in said non-volatile RAM module part.

9. The system of claim 1 wherein a portion of application programs used and related application data is stored in said non-volatile RAM module part.

10. The system of claim 1 wherein all application programs used and related application data is stored in said non-volatile RAM module part.

11. The system of claim 1 wherein said PC is replaced by a server.

12. The system of claim 1 wherein said memory controller is adapted to control DRAM as well as MRAM modules.

13. The system of claim 1 wherein an access to either DRAM or MRAM modules is performed by different Chip Select pins.

14. The system of claim 1 wherein configuration parameters are moved from battery backed DRAM to MRAM modules.

15. A method to accelerate a power-on sequence of a PC comprising the steps of:
(1) providing a memory controller and a main memory of the PC;
(2) implementing said main memory using partly non-volatile RAM modules and partly volatile RAM modules; and
(3) storing power-on self test codes in said non-volatile RAM modules.

16. The method of claim 15 wherein said non-volatile RAM modules are MRAM modules.

17. The method of claim 15 wherein said volatile RAM modules are DRAM modules

18. The method of claim 15 wherein said main memory consists exclusively of non-volatile RAM modules.

19. The method of claim 15 wherein power-on self test codes are stored in said non-volatile RAM module part.

20. The method of claim 15 wherein system configuration information is stored in said non-volatile RAM module part.

21. The method of claim 15 wherein device drivers associated with the system are stored in said non-volatile RAM module part.

22. The method of claim 15 wherein a portion of Operating system is stored in said non-volatile RAM module part.

23. The method of claim 15 wherein a portion of application programs used and related application data is stored in said non-volatile RAM module part.

24. The method of claim 15 wherein all application programs used and related application dada is stored in said non-volatile RAM module part.

25. The method of claim 15 wherein said PC is replaced by a server.

26. The method of claim 15 wherein said memory controller is adapted to control DRAM as well as MRAM modules.

27. The method of claim 15 wherein an access to either DRAM or MRAM modules is performed by different Chip Select pins.

28. The method of claim 15 wherein configuration parameters are moved from battery backed DRAM to MRAM modules.
